(19) United States
(12) Patent Application Publication
(10) Pub. No.: US 2004/0159195 A1
(43) Pub. Date: Aug. 19, 2004

(54) Screwdriver with multiple tip planes

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/366,377

(22) Filed: Feb. 14, 2003

(51) Int. Cl. B25B 23/00

(52) U.S. Cl. 81/439

(57) ABSTRACT

A screwdriver includes a handle with a shank and a tip end is formed on a distal end of the shank. The tip end includes three tip planes which are oriented in different directions with each other. The tip planes allows the shank of the screwdriver to be engaged with the bolt heads inclinedly.

### FIELD OF THE INVENTION

The present invention relates to a screwdriver that includes three tip planes so that the shank of the screwdriver can be inclined relative to a horizontal plane to unscrew a bolt with one of the top planes.

### BACKGROUND OF THE INVENTION

A conventional screwdriver is shown in FIG. 15 and generally includes a handle 1 and a shank 2 extends from an end of the handle 1 and a tip plane 3 is defined in a distal end of the shank 2. The shape of the tip plane can be made to be different so as to be matched with different types of bolt heads. The shank 2 has to be perpendicular to the top surface of the bolt head so that the tip plane 3 can be engaged with the bolt head. Nevertheless, if the bolt to be loosened is located in a narrow space and the shank 2 cannot be arranged to a proper orientation, then the tip plane cannot be used to loosen the bolt. A special tool is required and which is costly and seldom used.

The present invention intends to provide a screwdriver that has three tip planes which are orientated in different directions so that shank can be allowed to be used in an inclined way.

### SUMMARY OF THE INVENTION

In accordance with one aspect of the present invention, there is provided a screwdriver which comprises a handle with a shank extending from an end of the handle and an tip end is formed on a distal end of the shank. The tip end includes three tip planes which are oriented in different directions with each other.

The primary object of the present invention is to provide a screwdriver that has three tip planes in different directions so that one of the tip planes can be engaged with a bolt head while the shank is inclined relative to the bolt.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the screwdriver of the present invention;

FIGS. 2 and 3 show two different side views of the screwdriver of the present invention;

FIG. 4 shows a central tip plane is engaged with a bolt head;

FIG. 5 shows a lateral tip plane is engaged with a bolt head;

FIG. 6 shows the shank is inclined and a lateral tip plane is engaged with a bolt head;

FIG. 7 shows another embodiment of the screwdriver of the present invention and a bolt with a slotted head;

FIG. 8 shows the leading edges of the three tip planes are in flush with each other so as to engage with the slotted bolt head;

FIG. 9 shows yet another embodiment of the screwdriver of the present invention and a bolt with a Phillips head;

FIG. 10 shows that the screwdriver of the present invention shown in FIG. 9 is engaged with a Phillips head;

FIG. 11 is a perspective view to show another screwdriver of the present invention;

FIG. 12 shows a side view of the screwdriver as shown in FIG. 11;

FIG. 13 shows one of the tip planes of the screwdriver as shown in FIG. 12 is engaged with a slotted bolt head;

FIG. 14 shows another plane view of the screwdriver as shown in FIG. 13 is engaged with the slotted bolt head while the shank of the screwdriver is inclined, and

FIG. 15 is a perspective view to show a conventional screwdriver.

### DETAILED DESCRIPTION OF THE PREFERRED EMBODIMENT

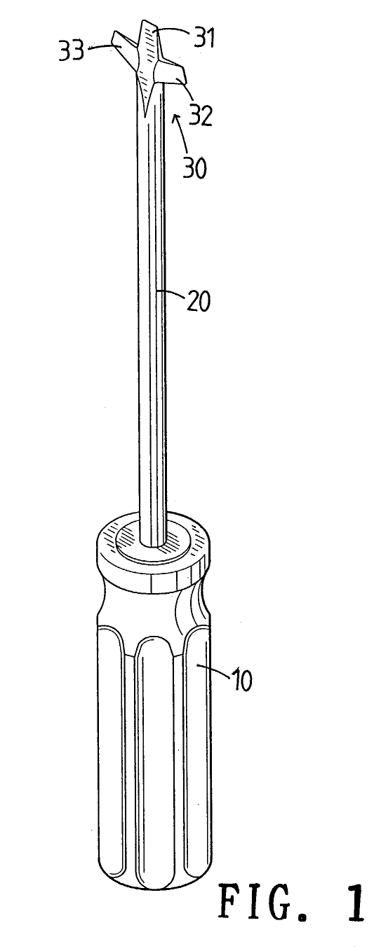

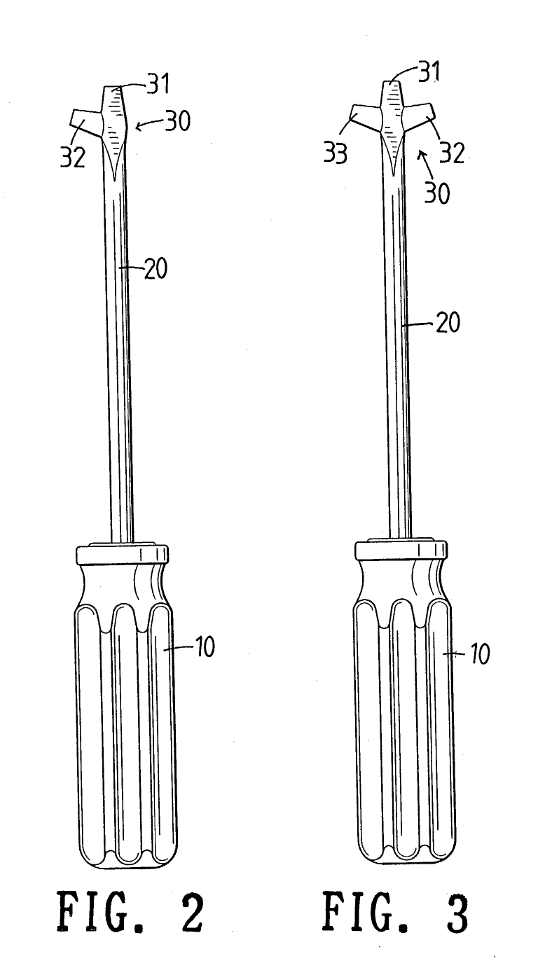

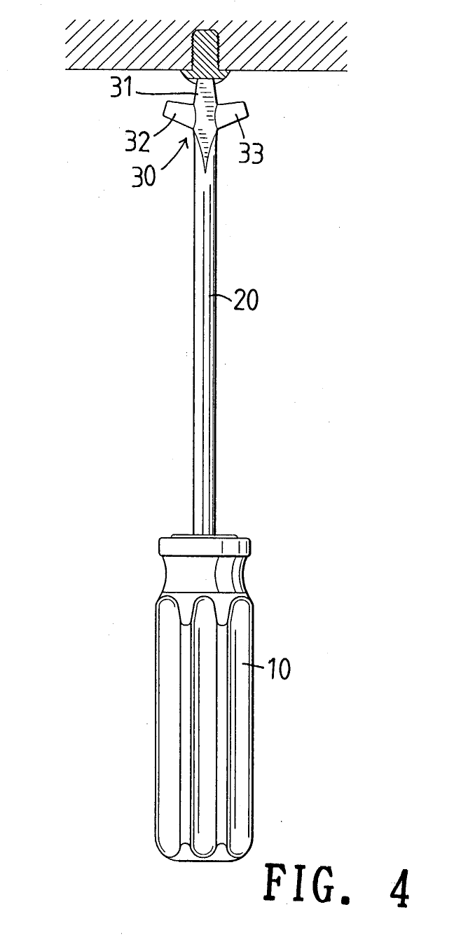

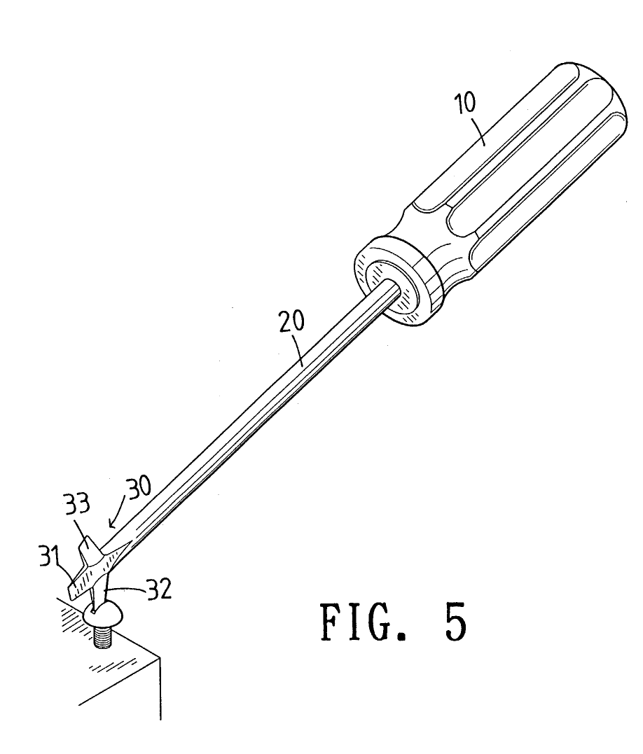

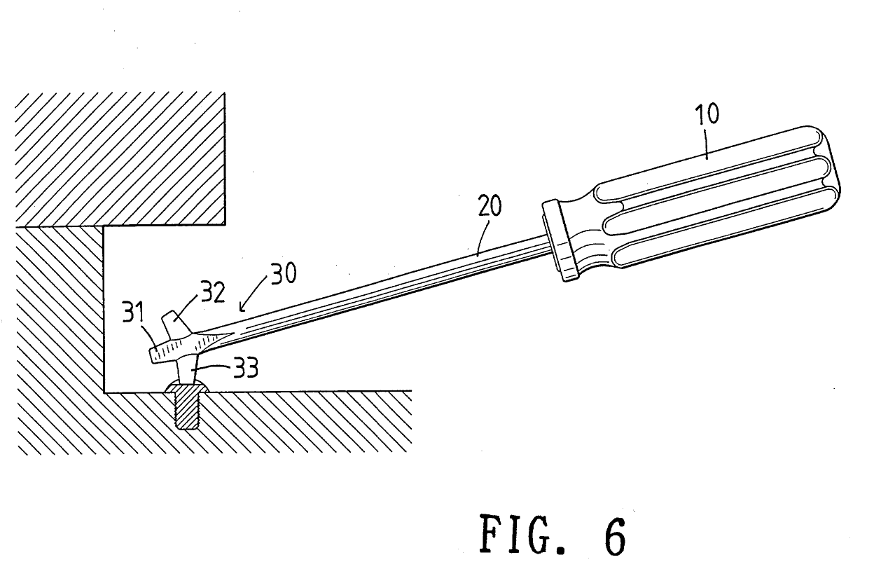

Referring to FIGS. 1 to 4, the screwdriver of the present invention comprises a handle 10 with a shank 20 extending from an end of the handle 10 and a tip end 30 is formed on a distal end of the shank 20. The tip end 30 includes three tip planes 31, 32, 33 which are oriented in different directions with each other. The tip plane 31 shares a common axis with the shank 20 as a conventional screwdriver and the other two tip planes 32, 33 are located in lateral directions of the top plane 31. The tip plane 31 can be used as a conventional screwdriver as shown in FIG. 4 and the other two tip planes 32, 33 can be engaged with a slotted head while the shank 20 of the screwdriver is tilt as shown in FIGS. 5 and 6.

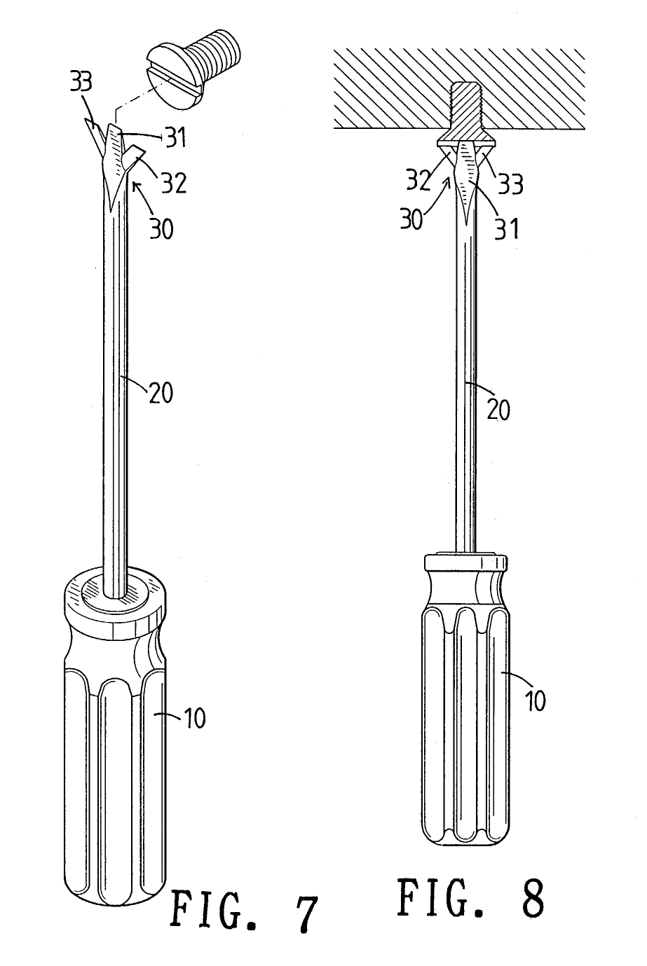

FIGS. 7 and 8, the three respective leading edges of each of the three tip planes 31, 32, 33 are in flush with each other so that the three leading edges of the three tip planes 31, 32, 33 can be engaged with the slot in the slotted head simultaneously. This allows the screwdriver to exert a torque to a bolt that has a large head.

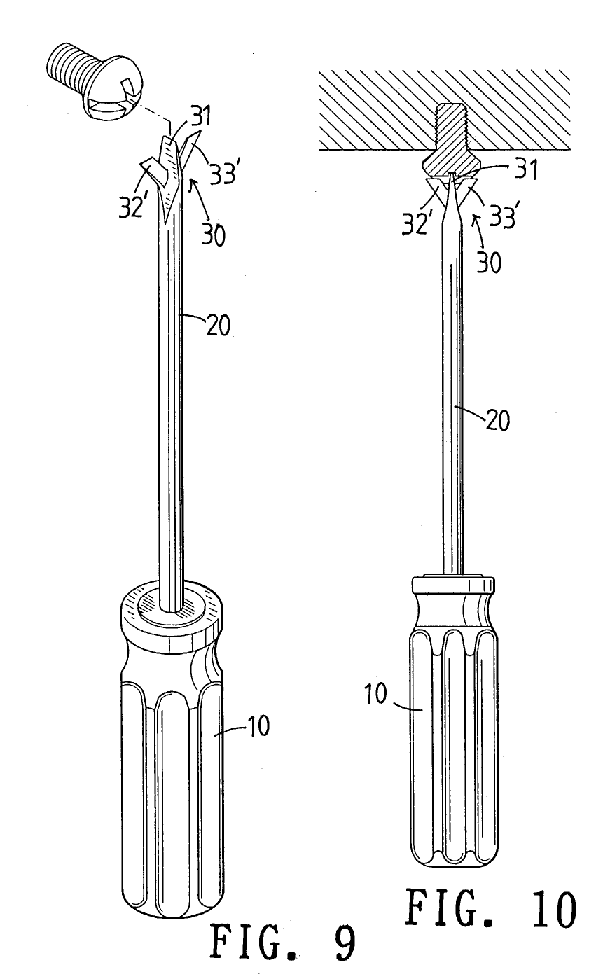

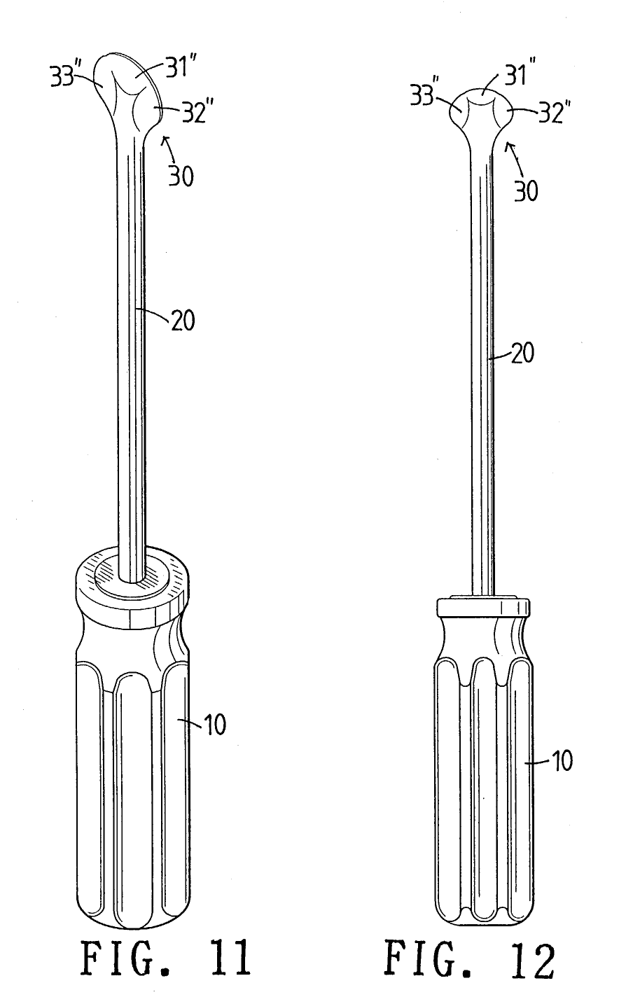

FIGS. 9 and 10 shows that the central one 31 of the three tip planes is perpendicular to the other two tip planes 32′ and 33′. This arrangement can be used to engaged with a Phillips head of a bolt.

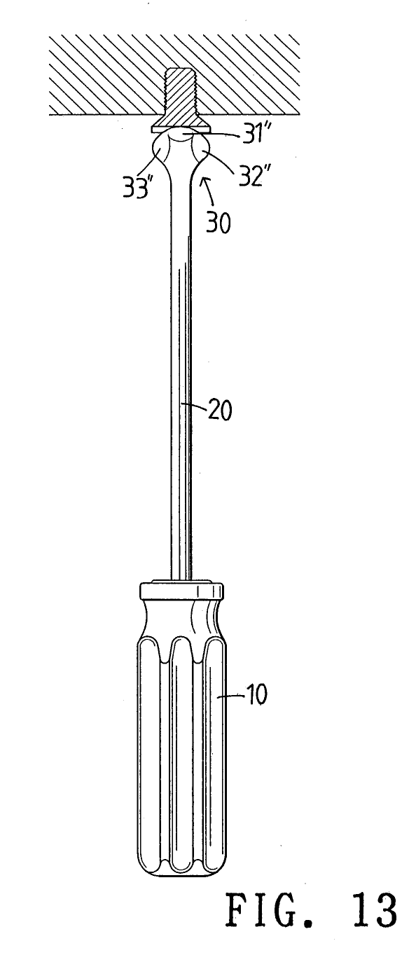

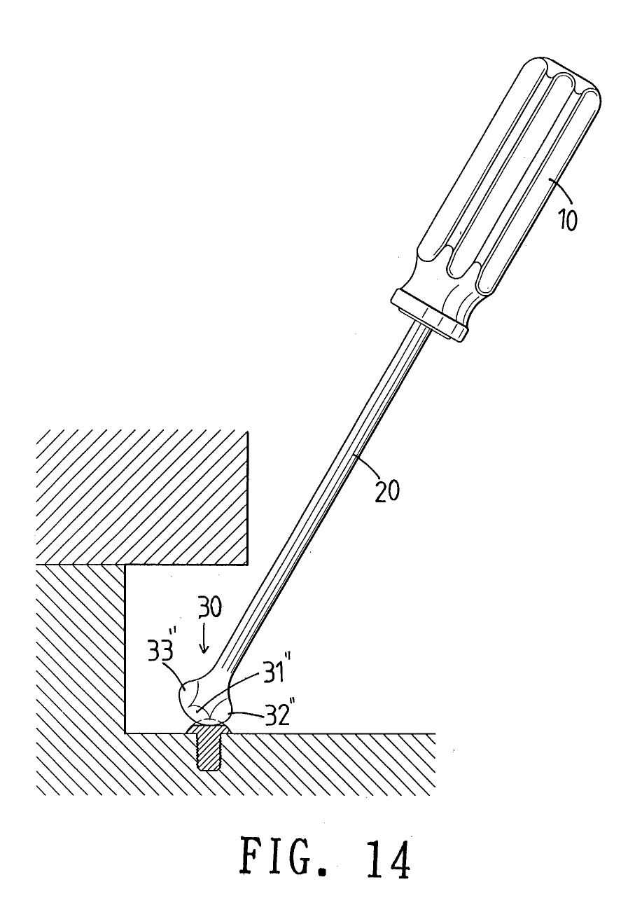

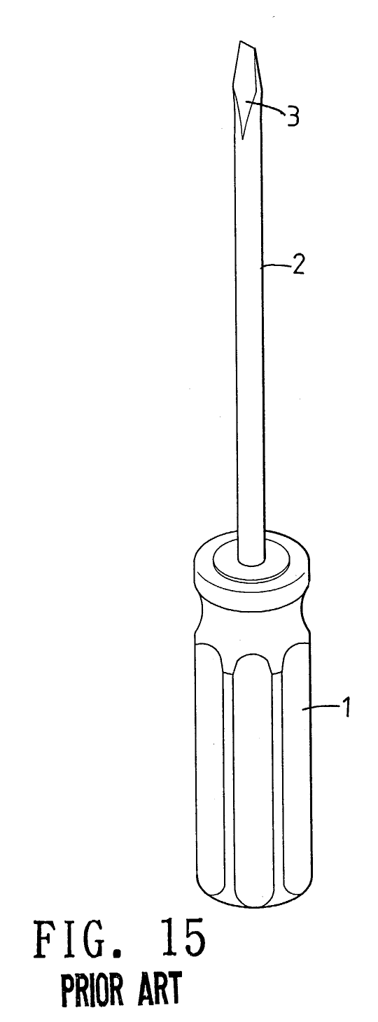

FIGS. 11 to 14 show that the three tip planes 31″, 32″, 33″ are connected with each other so as to form the tip end having a large area. The way of use is the same as the embodiment shown in FIGS. 4 to 6.

While we have shown and described the embodiment in accordance with the present invention, it should be clear to those skilled in the art that further embodiments may be made without departing from the scope of the present invention.

What is claimed is:

1. A screwdriver comprising:
a handle with a shank extending from an end of the handle and a tip end formed on a distal end of the shank, the tip end including three tip planes which are oriented in different directions with each other.

2. The screwdriver as claimed in claim 1, wherein three respective leading edges of each of the three tip planes are in flush with each other.

3. The screwdriver as claimed in claim 1, wherein one of the three tip planes is perpendicular to the other two tip planes.

4. The screwdriver as claimed in claim 1 wherein the three tip planes are connected with each other.
